(19) United States
(12) Patent Application Publication
(10) Pub. No.: US 2023/0383061 A1
(43) Pub. Date: Nov. 30, 2023

(54) POLYMERIC ALKYL SILICATES

(71) Applicant: WACKER CHEMIE AG, Munich (DE)

(72) Inventor: Elke Fritz-Langhals, Ottobrunn (DE)

(73) Assignee: Wacker Chemie AG, Munich (DE)

(21) Appl. No.: 18/032,823

(22) PCT Filed: Oct. 20, 2020
(86) PCT No.: PCT/EP2020/079521

§ 371 Date: Apr. 20, 2023

(51) Int. Cl. C08G 77/18

(52) U.S. Cl. CPC C08G 77/18

(57) ABSTRACT

Polymeric alkyl silicates along with processes for preparing the same. Where the polymeric alkyl silicates have the formula (I)

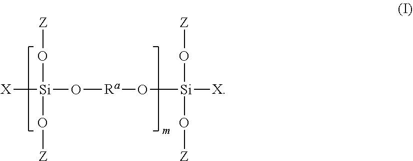

The invention relates to novel polymeric alkyl silicates.

Silicones are an industrially very important class of substances that are used in numerous fields of technology. Industrially important properties of silicones are for example their low tendency to crystallize, which distinguishes silicones from carbon-based polymers. Silicones remain liquid over wide temperature ranges and have very low glass transition temperatures.

However, due to the Si-bonded alkyl moieties present, silicones do not break down at all readily in the environment. This property increasingly limits the possible applications for silicones. There is accordingly a steadily growing demand for alternative materials that can in principle undergo hydrolytic cleavage but nevertheless have sufficient hydrolytic stability for practical uses and which are able to replace conventional silicones.

U.S. Pat. No. 3,992,429 and U.S. Pat. No. 4,132,664 disclose siliceous compounds of formula [(R^{a}O)₃SiO]₃Si—O—KW—O—Si[OSi(OR^{a})₃]₃, wherein KW represents a hydrocarbon radical. However, these systems have low molecular weight.

In many technical applications, however, low molecular weight compounds are undesirable because of their volatility and their migration behavior.

It is accordingly an object of the present invention to overcome the abovementioned disadvantages and provide polymeric alkyl silicates which have similar properties to silicones and can therefore replace silicones.

The object is achieved by the invention.

The invention provides polymeric alkyl silicates of formula (I)

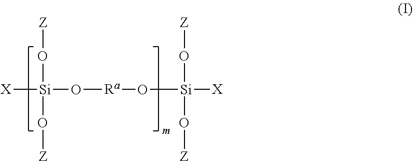

wherein
Z represents a radical of formula —Si(OR^{b})₃ or a radical of formula —CR^{c}₃,
R^{a} independently at each occurrence represents a divalent unsubstituted or substituted carbon-bonded radical or a divalent silicon-bonded radical,
R^{b} independently at each occurrence represents a monovalent unsubstituted or substituted hydrocarbon radical having 4 to 40 carbon atoms which is branched at the α-carbon atom or is doubly branched at the β-carbon atom,
R^{c} independently at each occurrence represents a monovalent unsubstituted or substituted hydrocarbon radical having 1 to 50 carbon atoms, by preference 1 to carbon atoms, preferably 1 to 5 carbon atoms,
X represents a halogen atom, an oxygen-bonded unsubstituted or substituted C₁- to C₄₀-hydrocarbon radical, wherein individual carbon atoms may be replaced by oxygen atoms, a radical of formula —O—Si(OR^{b})₃ or a radical of formula —OSiR^{x}₃,
R^{x} independently at each occurrence represents a monovalent unsubstituted or substituted to C₁- to C₄₀-hydrocarbon radical and
m represents an integer of at least 2, preferably at least 5 and at most 1000, by preference at most 500, preferably at most 100.

The term “branched” means that there are two carbon radicals on a carbon atom. The term “doubly branched” means that there are three carbon radicals on a carbon atom.

The radicals R^{a}, R^{b}, R^{c} and R^{x} and the radical X, when X is not a halogen atom, may be acyclic, cyclic, saturated or mono- or polyunsaturated or aromatic and may also have the following substitutions:

—OR¹, —NR¹₂, —SH, —SR¹, epoxy group, —COOR¹, —CHO, —CN, —OCOOR², —NR¹—COOR¹, —NR¹—CO—NR¹, —SiR¹₃ and —OSiR₃¹, wherein

R¹ represents a hydrogen atom or a monovalent to C₁- to C₁₈-hydrocarbon radical and

R² represents a monovalent to C₁- or C₁₈-hydrocarbon radical.

R^{a} independently at each occurrence preferably represents a divalent hydrocarbon radical having 1 to 200 carbon atoms, preferably having 3 to 50 carbon atoms, wherein the carbon atoms may be replaced by oxygen atoms or by siloxanyl radicals of formula —(R^{y}₂SiO)ₒ—SiR^{y}₂—, wherein
R^{y} independently at each occurrence represents a to C₁- to C₂₀-hydrocarbon radical, preferably a C₁- to C₆-hydrocarbon radical, and
o is an integer from 0 to 100, preferably an integer from 0 to 20.

Examples of radicals R^{a} are the 1,3-propylene, 1,4-butylene, 1,2-cyclohexylidene, 1,3-cyclohexylidene, 1,4-cyclohexylidene, 1,2-phenylene, 1,3-phenylene and 1,4-phenylene radical.

Further examples of radicals R a are the radical of formula

—CHR³—CHR³—(OCHR³—CHR³)ₚ—, wherein
R³ represents a hydrogen atom or a to C₁- to C₁₈-hydrocarbon radical, preferably a hydrogen atom or a methyl radical, and
p is an integer from 0 to 100, preferably 0 to 20,
and radicals of formulae
—(Me₂SiO)ₒ—Me₂Si—
—CH₂—CH₂—CH₂—(Me₂SiO)ₒ—Me₂Si—CH₂—CH₂—CH₂— and
—CH₂—(Me₂SiO)ₒ—Me₂Si—CH₂—,
wherein Me is a methyl radical and
o is as defined above.

Preferred examples of radicals R^{b} are the 2-butyl radical, the 3-methyl-2-butyl radical, the 3-methyl-2-pentyl radical, the 3-pentyl radical, the 2-hexyl radical, the 3-hexyl radical, the 2-heptyl radical, the 2-octyl radical, the 1-phenylethyl radical, the 1-phenyl-1-propyl radical, the 2,2-dimethyl-1-propyl radical, the 1,1-dimethylethyl radical and the 1,1-dimethylpropyl radical.

R^{c} independently at each occurrence preferably represents a linear or branched acyclic hydrocarbon radical having 1 to 50 carbon atoms, preferably a linear or branched acyclic hydrocarbon radical having 1 to 10 carbon atoms, particularly preferably a linear or branched acyclic hydrocarbon radical having 1 to 5 carbon atoms.

Examples of radicals R^{c} are the methyl, ethyl, n-propyl, n-butyl, n-pentyl, vinyl and allyl radical.

X preferably represents a chlorine atom, an oxygen-bonded unsubstituted or substituted to C₁- to C₄₀-hydrocarbon radical, in which individual carbon atoms may be replaced by oxygen, or radicals of formula —O—Si(OR^{b})₃ or —OSiR^{x}₃, wherein R^{x} independently at each occurrence preferably represents a C₁- to C₁₀-hydrocarbon radical.

Examples of radicals X are the chlorine atom, the 4-hydroxycyclohexyloxy radical, and radicals of formulae
—O—(CH₂—CH₂)₁—OH and —O—(CH₂—CH₂)ᵣ—OCH₃ where r=1-20,
—O—Si(CH₃)₃, —O—Si(2-BuO)₃, —O—SiH(CH₃)₂,
—O—Si(CH₃)₂—CH₂—CH₂—CH₂—NH₂,
—O—Si(CH₃)₂—CH₂—CH₂—CH₂—NH—CH₂—CH₂—NH₂,
—O—Si(CH₃)₂—CH═CH₂ and —O—Si(CH₃)₂—CH₂—CH₂—CH₂—O—CH₂-epoxy

Preferred examples of radicals Z are radicals of formulae (2-BuO)₃SiO— and CH₃—CH₂—C(CH₃)₂O—,

wherein 2-Bu is a 2-butyl radical.

Further examples of radicals Z are radicals of formulae
[CH₃—CH(CH₃)—CH(CH₃)O]₃SiO—,
[CH₃—C(CH₃)₂—CH₂O]₃SiO—, [(CH₃—CH₂)₂—CHO]₃SiO—,
[CH₃—(CH₂)₃—CH(CH₃)O]₃SiO—, [CH₃—(CH₂)₂—CH(C₂H₅)O]₃SiO—,
(CH₃)₃CO—, (C₂H₅)₃CO—, (n-C₃H₇)₃CO—, (n-C₄H₉)₃CO—, (n-C₅H₁₁)₃CO— and CH₃-CH₂—C(CH₃)₂O—.

The compounds of general formula (I) may be prepared in simple fashion, for example by reaction of [(R^{b}O)₃SiO]₂SiCl₂ or (R^{c}₃CO)₂SiCl₂ with a dihydroxy compound HO—R^{a}—OH, wherein R^{a}, R^{b} and R^{c} are as defined above. If an excess of [(R^{a}O)₃SiO]₂SiCl₂ or (R^{c}₃CO)₂SiCl₂ is present silicates of formula I with X=Cl are preferentially formed and if an excess of dihydroxy compound is present silicates of formula I with X=OR^{a}—OH are preferentially formed.

A further option is that of reacting the Si—Cl end groups present after the reaction with an alcohol or silanol.

The invention therefore provides a process for preparing the polymeric alkyl silicates according to the invention, characterized in that chlorosilanes (I) of formulae

[(R^{b}O)₃SiO]₂SiCl₂ or (R^{c}₃CO)₂SiCl₂

are reacted with dihydroxy compounds (2) of formula

HO—R^{a}—OH

or their salts,

umgesetzt werden,

wherein dihydroxy compounds (2) are employed in amounts of 0.1 to 10 mol, preferably 0.5 to 1.5 mol, of dihydroxy compound (2) per mol of chlorosilane (1), and R^{a}, R^{b} and R^{c} are each as defined above.

Examples of chlorosilanes (1) are
[(2-BuO)₃SiO]₂SiCl₂,
{[CH₃—CH(CH₃)—CH(CH₃)O]₃SiO}₂SiCl₂,
{[CH₃—CH₂—CH(CH₃)—CH(CH₃)O}₃SiO]₂SiCl₂,
{[(CH₃—CH₂)₂CHO]₃SiO}₂SiCl₂,
{[CH₃—(CH₂)₃—CH(CH₃)O]₃SiO}₂SiCl₂,
{[CH₃—(CH₂)₂—CH(C₂H₅)O}₃SiO]₂SiCl₂,
{[PhCH(CH₃)O]₃SiO}₂SiCl₂,
{[PhCH(C₃H₇)O]₃SiO}₂SiCl₂
{[CH₃—CH(CH₃)₂—CH₂O]₃SiO}₂SiCl₂,
{[CH₃—CH(CH₃)₂O]₃SiO}₂SiCl₂,
{[CH₃—CH₂—CH(CH₃)₂O]₃SiO}₂SiCl₂,
[(CH₃)₃CO]₂SiCl₂,
[(C₂H₅)₃CO]₂SiCl₂,
[(n-C₃H₇)₃CO]₂SiCl₂,
[(n-C₄H₉)₃CO]₂SiCl₂,
[(n-C₅H₁₁)₃CO]₂SiCl₂ and
[CH₃—CH₂—C(CH₃)₂O]₂SiCl₂,
wherein 2-Bu is a 2-butyl radical and Ph is a phenyl radical.

Preferred examples of chlorosilanes (1) are those of the formulae

[(2-BuO)₃SiO]₂SiCl₂ and [CH₃—CH₂—C(CH₃)₂O]₂SiCl₂,

wherein 2-Bu is a 2-butyl radical.

Examples of dihydroxy compounds (2) are ethylene glycol, propylene glycol, 1,3-propanediol, 1,4-butanediol, 2,4-pentanediol, 1,2-cyclohexanediol, 1,3-cyclohexanediol, 1,4-cyclohexanediol, 1,2-dihydroxybenzene, 1,3-dihydroxybenzene, 1,4-dihydroxybenzene, polyethylene glycol, polypropylene glycol, HO—SiMe₂—(O—SiMe₂)ₓ—OH and HO—CH₂—CH₂—CH₂—SiMe₂—(O—SiMe₂)ₓ—CH₂—CH₂—CH₂—OH, wherein x is an integer from 1 to 50 and Me is a methyl radical.

Preferred examples of dihydroxy compounds (2) are 1,4-cyclohexanediol, ethylene glycol, propylene glycol, triethylene glycol and polyethylene glycol.

The hydrogen chloride formed during the reaction may either be removed directly from the reaction mixture by distillation or extraction or hydrogen chloride-accepting bases or the dihydroxy compounds in the form of their salts are employed. Nitrogen bases are preferred.

Examples of bases are pyridine, ammonia, urea, diethylurea, ethylenediamine, methylamine, ethylamine, triethylamine, diethylamine, tributylamine, piperidine, pyrimidine, pyridazine, imidazole and diethylenetriamine.

Preferred examples of bases (3) are pyridine, ammonia, urea, ethylenediamine, triethylamine and tributylamine.

The process according to the invention may be performed in the presence of one or more solvents. Examples of solvents are hydrocarbons such as toluene or isohexane, ethers such as methyl tent-butyl ether or siloxanes such as hexamethyldisiloxane, octamethyltrisiloxane or (Me₃SiO)₄Si (where Me=methyl radical). The solvent is preferably employed in weight fractions of at least 1% to at most 100 times the amount by weight, particularly preferably from at least 10% to at most 10 times the amount by weight, in each case based on the total weight of components (1) and (2).

The process may be performed as a batch process, semi-batch process or as a continuous process. In a semi-batch process component (2) is preferably initially charged, optionally together with the base, and the component (1) added.

In a further embodiment preparation of the polymeric alkyl silicates of general general formula (I), wherein Z is a radical of formula —CR^{c}₃, is effected by reacting tetrachlorsilanes

with monohydroxy compounds (4) of formula

HO—CR^{c}₃,

and with dihydroxy compounds (2) of formula

HO—R^{a}—OH

or their salts
simultaneously in one step or successively in two steps, wherein monohydroxy compounds (4) are employed in amounts of 1.5 to 3.0 mol, preferably 1.8 to 2.2 mol, per mol of tetrachlorosilane and dihydroxy compounds (2) are employed in amounts of 1.5 to 3.0 mol, preferably 1.8 to 2.2 mol, per mol of tetrachlorosilane, and R^{a} and R^{c} are as defined above.

To this end for example 1 mol of tetrachlorosilane may be reacted with 2 mol of HO—C^{c}₃ and with 2 mol of the dihydroxy compound (2). It is preferable when HO—CR^{c}₃ is added initially and dihydroxy compound (2) is added subsequently.

The process according to the invention is performed at a temperature of by preference −20° C. to +250° C., preferably +20° C. to +150° C. It may be performed at the pressure of the surrounding atmosphere (about 1020 hPa) or at higher or lower pressures. It may preferably be performed at the pressure of the surrounding atmosphere.

The polymeric alkyl silicates according to the invention preferably have a molar weight Mₙ (number-average) of 5 000 to 50 000 and M_{w} (weight-average) of 10 000 to 100 000.

The molecular weight is determined by gel permeation chromatography (exclusion chromatography) using an Agilent MesoPore and OligoPore column, length 300 mm, internal diameter 7.5 mm, particle size 3/6 mm at 35° C., eluent toluene, flow rate 0.3 ml/min, RI-Detector and polydimethylsiloxane calibration.

The alkyl silicates of the formula (I) according to the invention have the advantage over the prior art that they are polymeric and thus non-volatile and therefore do not migrate in materials. They are additionally liquid and have very low glass transition temperatures despite their high molecular weight and are therefore suitable for replacing silicones. A further advantage of the alkyl silicates of formula (I) according to the invention is that they have a modular construction and their molecular weight is therefore alterable as desired. The chain ends of the alkyl siliconates according to the invention moreover bear reactive groups, for example chlorine or hydroxy groups, to which a multiplicity of further optionally functionalized moieties can be bonded. This makes it possible to broaden the spectrum of application of the alkyl silicates according to the invention.

The polymeric alkyl silicates according to the invention may be subjected to further processing, for example by crosslinking to afford elastomers, and employed where silicones are employed, for example in the sectors of hydrophobization, antifoam, textiles, cosmetics, buildings preservation and household care.

### EXAMPLES

The compound employed in the examples [(2-BuO)₃SiO]₂SiCl₂ is prepared from (2-BuO)₃SiOH and SiCl₄ as described, for example, in Abe, Bull. Soc. Chim. Jpn. 1969, 42, 111-1123.

The compound employed in the examples [CH₃—CH₂—C(CH₃)₂O]₂SiCl₂ is prepared from CH₃—CH₂—C(CH₃)₂OH and SiCl₄ hergestellt, as described for example in Docherty et al., Heiv. Chim. Acta 2018, 101, e1700298.

### Example 1

Polymers of formula (I) where R^{a}=1,4-cyclohexylidene, Z=Si(OR^{b})₃ where R^{b}=2-butyl, X=Cl, O—C₆H₁₀—OH and m=14.

1.54 g of [(2-BuO)₃SiO]₂SiCl₂ (2.44 mmol) in 0.5 ml of toluene are added dropwise to a mixture of 284 mg (2.44 mmol) of 1,4-cyclohexanediol and 430 mg (5.43 mmol) of pyridine in 1 ml of toluene. A white precipitate of pyridinium hydrochloride is formed. The mixture is then heated to 100° C. for 4 hours. The solution contains the polymeric product having Mₙ=10 000 Da/M_{w}=21 000. This gives m=14. The pyridinium hydrochloride precipitate formed is filtered off and the toluene is removed by rotary evaporation under vacuum. This affords a colorless oil having a dynamic viscosity n□□=1.13 Pas at 25° C. Glass transition temperature T_{g}=−107.6° C. ²⁹ Si—NMR (CD₂Cl₂): δ=−92.5 and −98.6 ppm in a ratio of 2:1.

### Example 2

Polymer of formula (I) where R^{a}=—CH₂—CH₂—(O—CH₂—CH₂)₂—, Z=Si(OR^{b})₃ where R^{b}=2-butyl, X=—CH₂—CH₂—(O—CH₂—CH₂)₂—OH and m=13.
3.07 g of [(2-BuO)₃SiO]₂SiCl₂(93 percent, 4.56 mmol) are admixed with 1 ml of toluene. A mixture of 737 mg (4.91 mmol) of triethylene glycol, 856 mg (10.8 mmol) of pyridine and 0.5 ml of toluene are slowly added to the solution. A white precipitate of pyridinium hydrochloride is formed immediately. The mixture is then heated to 100° C. for 4 hours. The solution contains the polymeric product having Mₙ=9700 Da/M_{w}=22 000.

This gives m=13.

²⁹ Si—NMR (CD₂Cl₂): δ=−92.3 and −96.8 ppm in a ratio of 2:1.

### Example 3

Polymer of formula (I) where R^{a}=—CH₂—CH₂—(O—CH₂—CH₂)₂—, Z=Si(OR^{b})₃ where R^{b}=2-butyl, X=—CH²—CH²—(O—CH₂—CH₂)₂—OH and m=13.

The procedure of example 2 is repeated at room temperature. After 3 hours, a polymer having
Mₙ=12 000 Da/M_{w}=24 000 Da is formed.

This gives m=13.

### Example 4

Polymer of formula (I) where R^{a}=—CH₂—CH₂—(O—CH₂—CH₂)₂—, Z=—C(CH₃)₂—CH₂—CH₃ and X=CH₂—CH₂—(O—CH₂—CH₂)₂—OH, Cl The procedure of example 2 is repeated with the exception that instead of [(2-BuO)₃SiO]₂SiCl₂ the compound of formula [CH₃—CH₂—C(CH₃)₂O]₂SiCl₂ is employed, the molar ratio of [CH₃—CH₂—C(CH₃)₂O]₂SiCl₂: triethylene glycol=1.0 and the reaction is carried out at 80° C. After 4 hours at 80° C. a polymer having Mₙ=15 500 Da/M_{w}=38 300 Da has formed and after a further 5 hours at 80° C. the mixture is worked up as described example 1. 6.2 g of the polymeric product are obtained as a colorless oil. Mₙ=16 900 Da/M_{w}=42 400 Da. This gives m=48. ²⁹ Si—NMR (CD₂Cl₂): δ=−89.72 ppm.

1-15. (canceled)

16. A polymeric alkyl silicate, comprising: wherein the polymeric alkyl silicate is of formula (I) 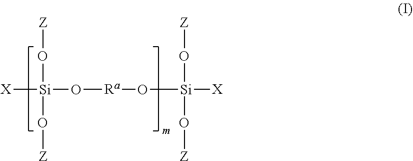
wherein Z represents a radical of formula —Si(OR^{b})₃ or a radical of formula —CR^{c}₃;
wherein R^{a} independently at each occurrence represents a divalent hydrocarbon radical having 3 to 200 carbon atoms, preferably having 3 to 50 carbon atoms, wherein the carbon atoms may be replaced by oxygen atoms or by siloxanyl radicals of formula —(R^{y}₂SiO)ₒ—SiR^{y}₂—;
wherein R^{y} independently at each occurrence represents a to C₁- to C₂₀-hydrocarbon radical, preferably a C₁- to C₆-hydrocarbon radical;
wherein o is an integer from 0 to 100, preferably an integer from 0 to 20;
wherein R^{b} independently at each occurrence represents a monovalent unsubstituted or substituted hydrocarbon radical having 4 to 40 carbon atoms which is branched at the α-carbon atom or is doubly branched at the β-carbon atom;
wherein R^{c} independently at each occurrence represents a monovalent unsubstituted or substituted hydrocarbon radical having 1 to 50 carbon atoms;
wherein X represents a halogen atom, an oxygen-bonded unsubstituted or substituted C_{1- to C}⁴⁰-hydrocarbon radical, wherein individual carbon atoms may be replaced by oxygen atoms, a radical of formula —O—Si(OR^{b})₃ or a radical of formula —OSiR^{x}₃;
wherein R^{x} independently at each occurrence represents a monovalent unsubstituted or substituted C₁- to C₄₀-hydrocarbon radical; and
wherein m represents an integer of at least 2 and at most 1000.

17. The polymeric alkyl silicate of claim 16, wherein m is an integer of at least 5 and at most 100.

18. The polymeric alkyl silicate of claim 16, wherein the radical R^{a} is selected from radicals of the group consisting of 1,3-propylene radical, 1,4-butylene radical, 1,2-cyclohexylidene radical, 1,3-cyclohexylidene radical, 1,4-cyclohexylidene radical, 1,2-phenylene radical, 1,3-phenylene radical, 1,4-phenylene radical and radicals of formulae
—CHR³—CHR³—(OCHR³—CHR³)ₚ−,
—(Me₂SiO)ₒ—Me₂Si—,
—CH₂—CH₂—CH₂—(Me₂SiO)O—Me₂Si—CH₂—CH₂—CH₂— and
—CH₂—(Me₂SiO)ₒ—Me₂Si—CH₂—;
wherein Me is a methyl radical;
wherein R³ represents a hydrogen atom or a C₁- to C₁₈-hydrocarbon radical, preferably a hydrogen atom or a methyl radical;
wherein o is an integer from 0 to 100, preferably an integer from 0 to 20; and
wherein p is an integer from 0 to 100, preferably 0 to 20.

19. The polymeric alkyl silicate of claim 16, wherein the radical R b is selected from the group consisting of 2-butyl radical, 3-methyl-2-butyl radical, 3-methyl-2-pentyl radical, 3-pentyl radical, 2-hexyl radical, 3-hexyl radical, 2-heptyl radical, 2-octyl radical, 1-phenylethyl radical, 1-phenyl-1-propyl radical, 2,2-dimethyl-1-propyl radical, 1,1-dimethylethyl radical and 1,1-dimethylpropyl radical.

20. The polymeric alkyl silicate of claim 16, wherein R^{b} independently at each occurrence represents a linear or branched acyclic hydrocarbon radical having 1 to 10 carbon atoms.

21. The polymeric alkyl silicate of claim 16, wherein Z is a radical of formula (2-BuO)₃SiO— or CH₃—CH₂—C(CH₃)₂O—.

22. A process for preparing polymeric alkyl silicates, comprising:
providing chlorosilanes (1) of formula
[(R^{b}O)₃SiO]₂SiCl₂ or (R^{c}₃CP)₂SiCl₂
that are reacted with dihydroxy compounds (2) of formula HO—R^{a}—OH or their salts, wherein the dihydroxy compounds (2) are present in amounts of 0.1 to 10 mol, preferably 0.5 to 1.5 mol, of dihydroxy compound (2) per mol of the chlorosilane (1);
wherein R^{a} independently at each occurrence represents a divalent hydrocarbon radical having 3 to 200 carbon atoms, preferably having 3 to 50 carbon atoms, wherein the carbon atoms may be replaced by oxygen atoms or by siloxanyl radicals of formula —(R^{y}₂SiO)ₒ—SiR^{y}₂—;
wherein R^{b} independently at each occurrence represents a monovalent unsubstituted or substituted hydrocarbon radical having 4 to 40 carbon atoms which is branched at the α-carbon atom or is doubly branched at the β-carbon atom;
wherein R^{c} independently at each occurrence represents a monovalent unsubstituted or substituted hydrocarbon radical having 1 to 50 carbon atoms; and
wherein R^{y} independently at each occurrence represents a C₁- to C₂₀-hydrocarbon radical, preferably a C₁- to C₆-hydrocarbon radical;

23. The process of claim 22, wherein the chlorosilanes (1) used are those of formula
[(2-BuO)₃SiO]₂SiCl₂ or [CH₃—CH₂—C(CH₃)₂O]₂SiCl₂,
wherein 2-Bu is a 2-butyl radical.

24. The process of claim 22, wherein the dihydroxy compounds (2) employed are 1,4-cyclohexanediol, ethylene glycol, propylene glycol, triethylene glycol or polyethylene glycol.

25. The process of claim 22, wherein the reaction is carried out in the presence of bases (3), preferably nitrogen bases.

26. The process of claim 25, wherein the bases (3) employed are pyridine, ammonia, urea, ethylenediamine, triethylamine or tributylamine.

27. A process for preparing the polymeric alkyl silicates, comprising:
providing tetrachlorsilanes that are reacted with monohydroxy compounds (4) of formula
HO—CR^{c}₃,
and with dihydroxy compounds (2) of formula
HO—R^{a}—OH or their salts
either simultaneously in one step or successively in two steps;
wherein the monohydroxy compounds (4) are present in amounts of 1.5 to 3.0 mol, preferably 1.8 to 2.2 mol, per mol of the tetrachlorosilane;
wherein the dihydroxy compounds (2) are present in amounts of 1.5 to 3.0 mol, preferably 1.8 to 2.2 mol, per mol of the tetrachlorosilane;
wherein R^{a} independently at each occurrence represents a divalent hydrocarbon radical having 3 to 200 carbon atoms, preferably having 3 to 50 carbon atoms, wherein the carbon atoms may be replaced by oxygen atoms or by siloxanyl radicals of formula —(R^{y}₂SiO)ₒ—SiR^{y}₂—;
wherein R^{c} independently at each occurrence represents a monovalent unsubstituted or substituted hydrocarbon radical having 1 to 50 carbon atoms; and
wherein R^{y} independently at each occurrence represents a C₁- to C₂₀-hydrocarbon radical, preferably a C₁- to C₆-hydrocarbon radical.

28. The process of claim 27, wherein R^{c} independently at each occurrence represents a linear or branched acyclic hydrocarbon radical having 1 to 10 carbon atoms.

29. The process of claim 27, wherein the reaction is carried out in the presence of bases (3), preferably nitrogen bases, preferably bases selected from the group of pyridine, ammonia, urea, ethylenediamine, triethylamine or tributylamine.
